(19) United States
(12) Patent Application Publication
(10) Pub. No.: US 2025/0203344 A1
(43) Pub. Date: Jun. 19, 2025

(54) METHODS AND APPARATUS FOR TRANSFERRING AN E-SIM FROM SOURCE DEVICE TO TARGET DEVICE IN A WIRELESS COMMUNICATION SYSTEM

(71) Applicant: Samsung Electronics Co., Ltd., Suwon-si (KR)

(72) Inventors: Sushant Singh SAROTE, Noida (IN); Atul GUPTA, Noida (IN)

(21) Appl. No.: 18/908,098

(22) Filed: Oct. 7, 2024

Related U.S. Application Data
(63) Continuation of application No. PCT/KR2024/012787, filed on Aug. 27, 2024.

(30) Foreign Application Priority Data
Dec. 15, 2023 (IN) 202311085941

(51) Int. Cl. H04W 8/20; H04W 8/18

(52) U.S. Cl. CPC H04W 8/205; H04W 8/183

(57) ABSTRACT

The disclosure relates to a 5G or 6G communication system for supporting a higher data transmission rate. A method performed by a target device is provided. The method comprises detecting a request to transfer an e-sim from a source device to the target device, wherein the source device and the target device are associated with a common OEM entity; and receiving from a MNO entity, a new profile for the e-sim for download and activation at the target device, thereby completing the transfer of the e-sim, wherein a determination that the target device is prior to the source device is performed by the common OEM entity, and wherein a first transaction indicative of a request to generate the new profile for the e-sim for the target device and deletion of the e-sim from the source device is triggered by the common OEM entity upon the determination.

### CROSS-REFERENCE TO RELATED APPLICATION(S)

This application is a continuation application, claiming priority under § 365 (c), of an International application No. PCT/KR2024/012787, filed on Aug. 27, 2024, which is based on and claims the benefit of an Indian Patent Application number 202311085941, filed on Dec. 15, 2023, in the Indian Patent Office, the disclosure of which is incorporated by reference herein in its entirety.

### FIELD OF THE INVENTION

The disclosure relates to transfer of subscriber identity module (SIM). More particularly, the disclosure relates to system and method for transfer of an embedded subscriber identity module (e-sim) from a source device to a target device.

### BACKGROUND

5^{th} generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter-wave (mmWave) including 28 GHz and 39 GHz. In addition, it has been considered to implement 6^{th} generation (6G) mobile communication technologies (referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide system and method for transfer of an embedded subscriber identity module (e-sim) from a source device to a target device.

Additional aspects will be set forth in part in the description which follows and, in part, will be apparent from the description, or may be learned by practice of the presented embodiments.

In accordance with an aspect of the disclosure, a target device is provided. The target device includes transceiver, memory storing one or more computer programs, and one or more processors communicatively coupled with the transceiver and the memory, wherein the one or more computer programs include computer-executable instructions that, when executed by the one or more processors individually or collectively, cause the target device to detect a request to transfer an embedded subscriber identity module (e-sim) from the source device to the target device, wherein the source device and the target device are associated with a common original equipment manufacturer (OEM), receive, from a mobile network operator (MNO) entity, a new profile for the e-sim for download and activation at the target device, thereby completing the transfer of the e-sim, wherein a determination that the target device is prior to the source device is performed by the common OEM entity, wherein a first transaction indicative of a request to generate a new profile for the e-sim for the target device and deletion of the e-sim from the source device is triggered by the common OEM entity upon the determination.

In accordance with another aspect of the disclosure, a mobile network operator (MNO) is provided. The MNO entity includes a transceiver configured to receive and transmit a signal, memory storing one or more computer programs, and one or more processors communicatively coupled to the transceiver and the memory, wherein the one or more computer programs include computer-executable instructions that, when executed by the one or more processors individually or collectively, cause the MNO entity to receive, from a user associated with the target device, a request to transfer an embedded subscriber identity module (e-sim) from the source device to the target device, wherein the source device is associated with a source original equipment manufacturer (OEM) and the target device is associated with a target OEM entity different from the source OEM entity, request the target OEM entity to register the e-sim with the target OEM, generate a new profile of the e-sim, and transmit the new profile to the target device via the target OEM entity for download and activation at the target device, thereby completing the transfer of the e-sim.

In accordance with another aspect of the disclosure, a method performed by a target device is provided. The method includes detecting, by the target device, a request to transfer an embedded subscriber identity module (e-sim) from the source device to the target device, wherein the source device and the target device are associated with a common original equipment manufacturer (OEM), receiving, by the target device from a mobile network operator (MNO) entity, a new profile for the e-sim for download and activation at the target device, thereby completing the transfer of the e-sim, wherein a determination that the target device is prior to the source device is performed by the common OEM entity, and wherein a first transaction indicative of a request to generate a new profile for the e-sim for the target device and deletion of the e-sim from the source device is triggered by the common OEM entity upon the determination.

In accordance with another aspect of the disclosure, a method performed by a mobile network operator (MNO) entity having an MNO controller is provided. The method includes receiving, by the MNO entity from a user associated with the target device via the MNO controller, a request to transfer an embedded subscriber identity module (e-sim) from the source device to the target device, wherein the source device is associated with a source original equipment manufacturer (OEM) and the target device is associated with a target OEM different from the source OEM, requesting, by the MNO entity, the target OEM entity to register the e-sim with the target OEM, generating, by the MNO entity, a new profile of the e-sim, transmitting, by the MNO entity, the generated new profile to the target device via the target OEM entity for download and activation at the target device, thereby completing the transfer of the e-sim.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an existing e-sim transfer architecture, according to the related art;

FIG. 2A illustrates an overview of an environment comprising a system for transfer of e-sim from a source device to a target device, according to an embodiment of the disclosure;

FIG. 2B illustrates a detailed block diagram associated with a target device, a common OEM entity, and a MNO entity, according to an embodiment of the disclosure;

FIG. 3 illustrates a process flow to detect whether transfer of e-sim is required, according to an embodiment of the disclosure;

FIG. 4 illustrates a device precedence graph and a device state table, according to an embodiment of the disclosure;

FIG. 5A illustrates an architecture for event management in an OEM entity and a MNO entity, according to an embodiment of the disclosure;

FIG. 5B illustrates a sequence diagram for Subscription Managed Discovery Service (SM-DS) as device proxy for eSIM events, according to an embodiment of the disclosure;

FIG. 6A illustrates a stepwise sequence flow for transfer of an e-sim from a source device to a target device, according to an embodiment of the disclosure;

FIG. 6B illustrates a stepwise sequence flow for transfer of an e-sim from a source device to a target device, according to an embodiment of the disclosure;

FIG. 6C illustrates a stepwise sequence flow for transfer of an e-sim from a source device to a target device, according to an embodiment of the disclosure;

FIG. 7 illustrates a process flow of a method for transferring an e-sim from a source device to a target device, according to an embodiment of the disclosure;

FIG. 8 illustrates an overview of an environment comprising a system for transfer of an e-sim from a source device to a target device, according to an embodiment of the disclosure;

FIG. 9 illustrates a tree-based hierarchy stored at the device priority data unit, according to an embodiment of the disclosure;

FIG. 10 illustrates a line diagram illustrating a process for inter-OEM transfer of an e-sim from a source device to a target device, according to an embodiment of the disclosure;

FIG. 11 illustrates another line diagram illustrating a process for inter-OEM transfer of an e-sim from a source device to a target device using a third-party discovery server, according to an embodiment of the disclosure;

FIG. 12 illustrates another line diagram illustrating a process for intra-OEM transfer of an e-sim from a source device to a target device, according to an embodiment of the disclosure;

FIG. 13 illustrates a process flow of a method for transferring an e-sim from a source device to a target device, according to an embodiment of the disclosure;

FIG. 14 illustrates a detailed process flow of a method for transferring an e-sim from a source device to a target device, according to an embodiment of the disclosure;

FIG. 15 illustrates a block diagram of a user equipment (UE or terminal) according to an embodiment of the disclosure; and

FIG. 16 illustrates a block diagram of a base station (BS) according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

In recent years, the telecommunications industry has witnessed a shift in mobile connectivity with the advent of embedded subscriber identity modules (e-sims). Traditional SIMs were earlier being used for mobile devices and are characterized by their physical and removable nature. With the increase in demand for enhanced user experiences, e-sims are now being utilized. The e-sims allows users to activate a cellular plan from network operator without having to use a physical SIM.

E-sims enable users to activate and switch between mobile networks. Further, e-sims may enable users to utilize multiple devices in a connected environment. E-sim switching is thus becoming a common activity since in order to use the same number, i.e., Mobile Station International Subscriber Directory Number (MSISDN), the users need to transfer the e-sim from the current device to the new device.

As per existing mechanisms, switching of e-sim from one device to another device required network operator's intervention, however, such mechanism is time-consuming and not user-friendly. Original Equipment Manufacturers (OEMs) have collaborated with Mobile Network Operators (MNOs) to improve e-sim transfers however there still exist drawbacks with existing mechanisms.

As per one existing mechanism, MNO has burden of each device for all the e-sim configurations. An e-sim may request for transfer to the MNO via Short Messaging Service (SMS) having e-sim ID (ICCID) and International Mobile Equipment Identity (IMEI) details. A quick response (QR)-code may be shared with the user to install the e-sim. As per another existing mechanism, push service may be provided in conjunction with the MNO server and the server of the OEM.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

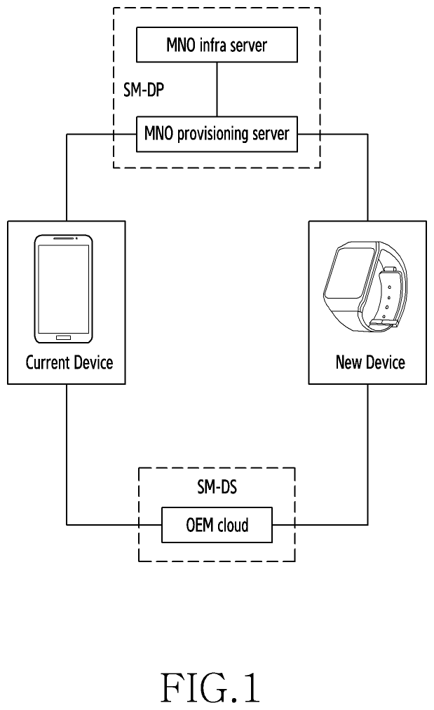

FIG. 1 illustrates an existing e-sim transfer architecture according to the related art.

The existing architecture utilize multiple interfaces, such as, interface for communication between devices and OEM cloud or Subscription Managed Discovery Service (SM-DS), interface for communication between OEM cloud (SM-DS) and MNO servers, and interface for communication between MNO infra server and MNO provisioning server. The MNO cloud may be associated with Subscription Manager Data Preparation (SM-DP). The current device and the new device may be associated with corresponding Embedded Universal Integrated Circuit Cards (eUICCs). Further, the e-sim may be associated with Integrated Circuit Card Identifier (ICCID).

MNO infra server manages access, authentication, authorization, subscription, billing, and other associated management functions for cellular wireless services for the devices. The MNO provisioning servers enable communication of e-sim data to the eUICCs. The SM-DS allows the source and target mobile wireless devices to communicate indirectly with each other.

A general process flow for transfer of e-sim from the current device (eUICC1) to new device (eUICC2) as per conventional techniques will now be described. Initially, at step 0, eUICC1 of current device is mapped to the e-sim at the MNO cloud. At step 1, in order to initiate e-sim transfer, nearby communication of the current device and the new device is necessary. The current device gets the eUICC information of the new device from nearby communication, since this information is to be sent to the MNO server to map the e-sim to the eUICC2 (new device). Nearby communication is a mandatory condition which is a drawback in existing mechanisms.

Next, at step 2, the new device sends information of eUICC2 to the current device, which sends information of both eUICC1 and eUICC2 to the OEM cloud (SM-DS) with a request to assign the e-sim to eUICC2. At step 3, the OEM Cloud (SM-DS) communicates the information to MNO cloud to assign e-sim to eUICC2. At step 4, the MNO server (SM-DP) confirms that the eUICC2 is assigned to e-sim and sends a download link to the OEM Cloud (SM-DS). At step 5, the OEM Cloud (SM-DS) sends the download link to the current device and the current device sends the download link to the new device via nearby communication. At step 6, the OEM Cloud (SM-DS) may push MNO address and add event for the new device (eUICC2). The new device may use the download link and download the e-sim profile from the MNO server (SM-DP).

Here, the current device may delete the e-sim before the new device has activated the e-sim, thereby increasing the risk that in case of both devices losing the e-sim due to abnormality, the user has no way to recover the e-sim and would have to contact the network operator. Additionally or alternatively, the current device may not delete the e-sim when the new device gets the e-sim, thereby increasing the possibility that if any abnormality happens then both the current and new devices have duplicate e-sims. Moreover, the existing mechanism would work only when the current device and the new device share the same OEM.

Accordingly, switching of e-sims from one device to another device becomes more difficult when the device initially (i.e., a source device) having the e-sim is far away from the other device (i.e., a target device) or is switched off, unavailable, or not working. In particular, the existing mechanism require the source device to perform a lot of processes to transfer the e-sim. Examples of such processes include, initiating e-sim transfer request, retrieving embedded Universal Integrated Circuit Card (eUICC) information related to the target device via nearby communication, sharing the eUICC information with the MNO, performing authentication, and so forth. Thus, if the source device is switched off or placed distant apart from the target device, it is really difficult to perform e-sim transfer using the existing mechanism. Even, the existing push mechanism that tackles with unburdening of MNO, require the source device to be in proximity of the target device. More specifically, the existing mechanism require the source device to initiate the required e-sim transfer.

Further, there is no event-based e-sim transfer mechanisms available as per existing mechanisms. Moreover, as per existing mechanism, in case the devices are of different OEMs, user may require intervention from MNOs to transfer the e-sim, which is time consuming. Furthermore, the existing mechanisms for e-sim transfer are time consuming, required safe nearby communication technique, and so forth.

Accordingly, there is a need for systems and methods that overcome at least some of the above-mentioned limitations.

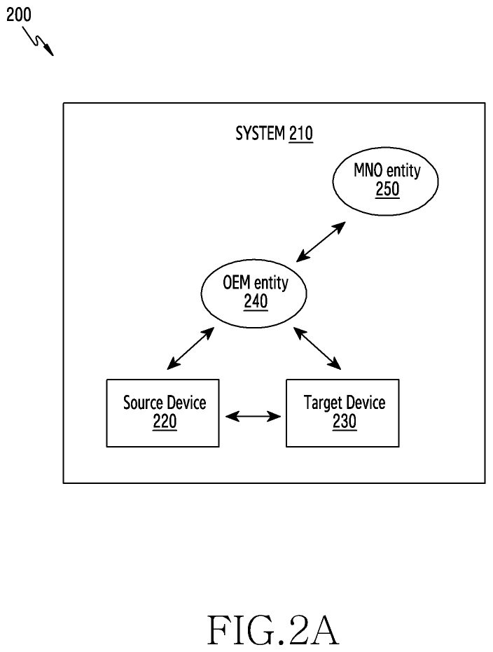

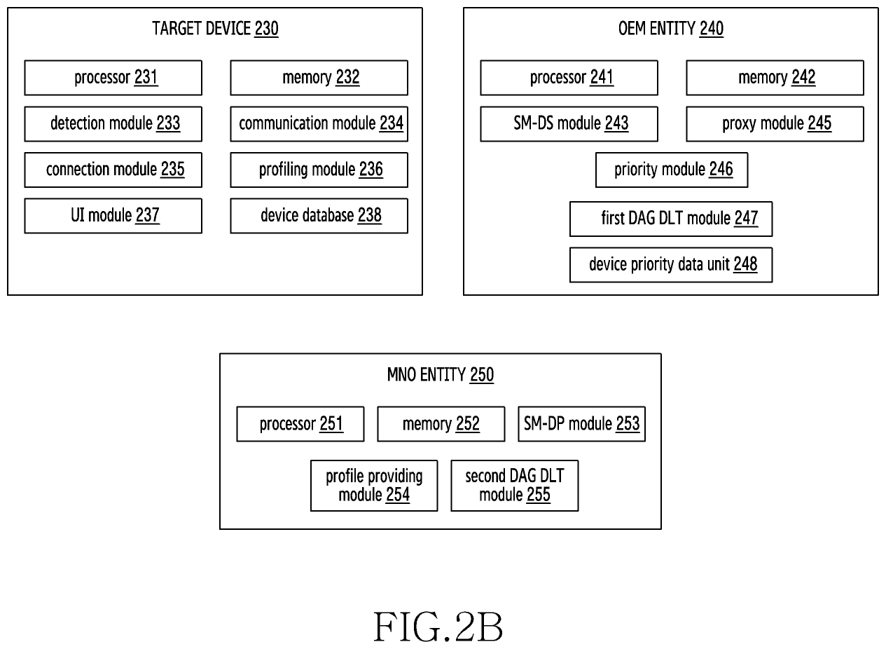

FIG. 2A illustrates an overview of an environment 200 comprising a system 210 for transfer of e-sim from a source device 220 to a target device 230 according to an embodiment of the disclosure.

FIG. 2B illustrates a detailed block diagram associated with a target device, a common OEM entity, and a MNO entity according to an embodiment of the disclosure.

The source device 220 and the target device 230 share a common Original Equipment Manufacturer (OEM). The system 210 comprises a common OEM entity 240, a Mobile Network Operator (MNO) entity 250, the source device 220, and the target device 230.

The common OEM entity 240 may be associated with Subscription Managed Discovery Service (SM-DS) and the MNO entity 250 may be associated with Subscription Manager Data Preparation (SM-DP). The source device 220 may be associated with Embedded Universal Integrated Circuit Cards (eUICC1) and the second device may be associated with eUICC2. The e-sim may be associated with Integrated Circuit Card Identifier (ICCID).

The target device 230 may include a processor 231, memory 232, a detection module 233, a communication module 234, a connection module 235, a profiling module 236, a user interface (UI) module 237, and a device database 238. Similar to the target device, the source device 220 may also include respective processor, memory, and the multiple modules which have not been shown for sake of brevity.

The common OEM cloud 240 may include a processor 241, memory 242, a SM-DS module 243, a proxy module 245, a priority module 246, a first Directed Acyclic Graph (DAG) Decentralized Ledger (DLT) module 247, and a device priority data unit 248. The SM-DS module 243 may be considered as a-sim profile events noticeboard of device and push mechanism for events.

The MNO entity 250 may include a processor 251, memory 252, a SM-DP module 253, a profile providing module 254, and a second DAG DLT module 255. The SM-DP module 253 is configured to prepare, store and protect operator profiles and facilitate download of profiles onto the eUICCs. The profile providing module 254 refers to the MNO profiling address which the target device 230 has to connect to for downloading profile.

Hereinafter, it is understood that terms including “unit” or “module” at the end may refer to the unit for processing at least one function or operation and may be implemented in hardware, software, or a combination of hardware and software.

Each of the source device 220, the target device 230, the common OEM entity 240 includes corresponding processors and memories. Further, the source device 220, the target device 230, the common OEM entity 240 may include corresponding communication units. The corresponding communication unit may perform functions for transmitting and receiving signals. The corresponding memory may include executable instructions that, when executed by the corresponding processors, cause the system to perform the steps as described in the disclosure.

As an example, the corresponding processors may each be a single processing unit or a number of units, all of which could include multiple computing units. The corresponding processors may be implemented as one or more microprocessors, microcomputers, microcontrollers, digital signal processors, central processing units, state machines, logic circuitries, and/or any devices that manipulate signals based on operational instructions. Among other capabilities, the corresponding processor are configured to fetch and execute computer-readable instructions and data stored in the corresponding memory. The corresponding processor may include one or a plurality of processors. At this time, one or a plurality of processors may be a general-purpose processor, such as a central processing unit (CPU), an application processor (AP), or the like, and an AI-dedicated processor such as a neural processing unit (NPU). The corresponding processor may control the processing of input data in accordance with a predefined operating rule or artificial intelligence (AI) model stored in the non-volatile memory and the volatile memory, i.e., the corresponding memory. The predefined operating rule or artificial intelligence model is provided through training or learning.

The corresponding memory may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In some embodiments, the OEM entity 240 and the MNO entity 250 may be implemented as dedicated hardware units. In some embodiments, the OEM entity 240 and the MNO entity 250 may be implemented in the form of virtualized software units in hardware or cloud environments.

The embodiments disclosed herein can be implemented through at least one software program running on at least one hardware device and performing network management functions to control the elements. The elements can be at least one of a hardware device, or a combination of hardware device and software module.

Referring to FIGS. 2A and 2B, details of the disclosure will now be described. It is appreciated that the steps performed by the target device, the source device, the OEM entity, and the MNO entity may be performed by the respective processors and modules.

The target device 230 may detect a request to transfer the e-sim from the source device to the target device. In particular, the detection module 233 may detect the request to transfer the e-sim. In an embodiment, the detection may be an automatic detection based on fulfilment of a predetermined criteria. In another embodiment, the detection may be manual detection initiated by the user of the source device 220 and the target device 230. In the manual detection, the detection may be based on a user request received from user. The user request may be indicative of initiation of the transfer of e-sim from the source device to the target device.

In the automatic detection, a transfer event indicating that transfer from the target device is detected at a private cloud of the user of the target device 230 and the source device 220. The detection module 233 determines whether the transfer event fulfils the predetermined criteria and upon the determination that the transfer event fulfils the predetermined criteria, the detection module 233 detects the request to transfer the e-sim.

In an embodiment, the predetermined criteria may be a distance between the source device 220 and the target device 230.

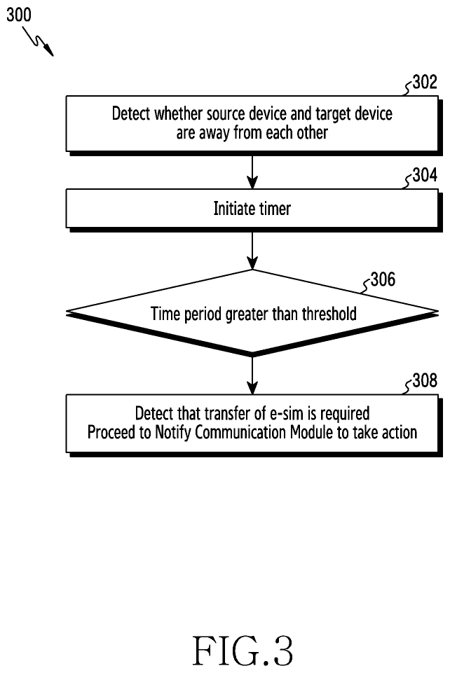

FIG. 3 illustrates a process flow to detect whether transfer of an e-sim is required, according to an embodiment of the disclosure.

Referring to FIG. 3, in a process flow 300, at operation 302, the detection module 233 detects whether the source device 220 and the target device 230 are in Near Field Communication (NFC) range or Bluetooth range. That is, the detection module 233 detects a proximity event indicating that the target device 230 is a pre-determined distance away from the source device 220.

At operation 304, the detection module 233 initiates a timer upon detecting the proximity event to measure a time period of the target device 230 being the pre-determined distance away from the source device 220. The proximity event may be detected based on signal throughput in bites per second of data exchange and/or based on Received Signal Strength Indicator (RSSI) power of signal. At operation 306, the detection module 233 may determine whether the time period is greater than a threshold time duration. The threshold time duration may be pre-stored in the memory 232. At operation 308, the detection module 233 may detect that the transfer is required upon a determination that the time period is greater than the threshold time duration. The detection module 233 may then notify the communication module 234 to trigger the e-sim transfer. The timer may then be reset and the detection module 233 may be on hold still successful intimation of the e-sim transfer.

Referring again to FIGS. 2A and 2B, the communication module 234 may be configured to provide connectivity with the OEM cloud (SM-DS) using Wi-Fi, Internet hotspot, Radio Access Network (RAN), over the air interface, and the like. The communication module 234 may be configured to check the OEM information from the device database 238 and obtains the OEM entity (SM-DS) address from the device database 238. The communication module 234 may interact with the connection module 235 to establish connection with the common OEM entity 240.

The communication module 234 may further be configured to notify the profiling module 236 once the e-sim transfer is complete in order to facilitate downloading of the e-sim profile. As will be described further below, once the transfer of e-sim is complete, the MNO entity 250 notifies the common OEM entity 240 with the download link of the e-sim profile. The profiling module 236 receives the download link and initiates e-sim download procedure by connecting with the MNO entity 250 (in particular, the SM-DP module 253) via the connection module 235. The profiling module 236 is further configured to retrieve e-sim events for corresponding eUICCs (here, eUICC2) which are pushed by common OEM entity 240 via Local Profile Assistant (LPA) polling mechanism. Similarly, the profiling module of the source device 220 may also retrieve e-sim events for eUICC1.

The UI module 237 is configured to enable the user to initiate the e-sim transfer by sending a user request for e-sim transfer in case of manual detection. Further, the UI module 237 enables the user to select an appropriate value for the timer to detect whether transfer of e-sim is required in case of automatic detection. Further, the UI module 237 enables the user to access and update the device priority data unit 248, as will be described further below.

Further, the common OEM entity 240 is configured to determine a priority of the target device 230 with respect to the source device 220. The common OEM entity 240 may comprise a database that stored the device priority data unit 248. The device priority data unit 248 may indicate the priorities of the source device 220, the target device 230, and one or more additional devices of the user with respect to each other. The device priority data unit 248 may indicate corresponding identifiers and states of the source device 220, the target device 230, and the one or more additional devices. The common OEM entity 240 may determine the priority by accessing the database. For e-sim transfer to happen automatically, the priority of the target device 230 should be greater than the priority of the source device 220.

The device priority data unit 248 may be accessed by the user via a user account of the user. The user may use the UI module 237 to access and update the device priority data unit 248. For instance, the OEM entity 240 may receive a user input indicative of registration of the source device 220, the target device 230, and the one or more additional devices using corresponding eUICCs via the user account. Further, the OEM entity 240 may receive another user input indicative of one or more of establishing or changing corresponding priorities of the source device 220, the target device 230, and the one or more additional devices in the device priority data unit 248 via the user account. The device priority data unit 248 can thus be updated based on the user inputs.

In an embodiment, the device priority data unit 248 may include a device state table indicating corresponding identifiers and states of the source device 220, the target device 230, and one or more additional devices. Further, the device priority data unit 248 may include a device precedence graph indicating a priority of the source device 220, the target device 230, and one or more additional devices with respect to each other. Thus, at the OEM entity 240, the user can change priorities of the devices, for executing e-sim transfer transactions.

In the OEM entity 240, each e-sim may be mapped to an eUICC and a SM-DS. A tree-based hierarchy of priorities of eUICC (devices) may be stored at the OEM entity 240.

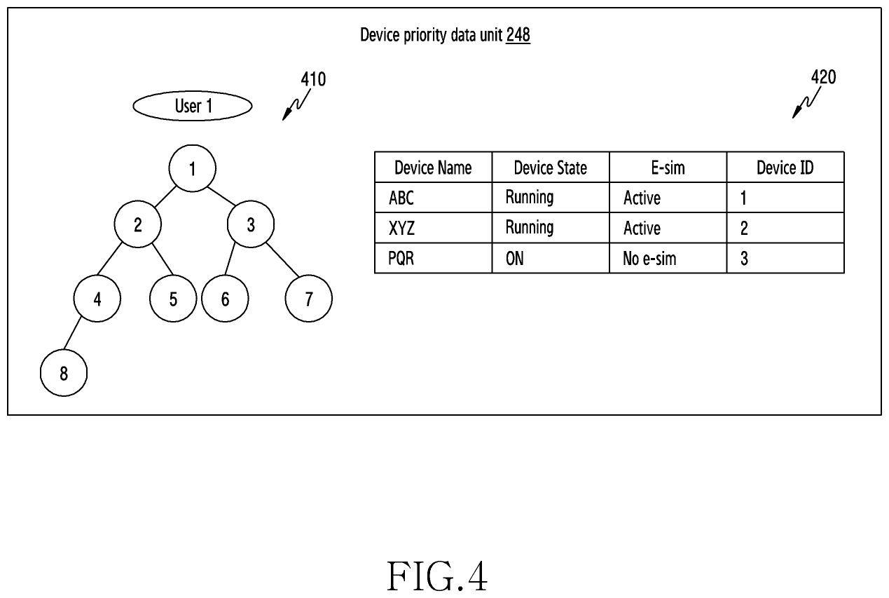

FIG. 4 illustrates a device precedence graph and a device state table for a given user according to an embodiment of the disclosure.

Referring to FIG. 4, with regards to a device precedence graph 410 and a device state table 420, the priority module 246 may be configured to facilitate registration of the devices at the device priority data unit 248 and to change the priority of the devices. As an example, priority of the device 1 is higher than device 8 in the depicted device precedence graph 410, however, if required, the user may update the priorities of the devices such that priority of the device 8 is higher than device 1. Based on the device priority data unit 248, if the target device 230 has higher priority than the source device 220, then the e-sim transfer can happen automatically. In particular, a higher priority device (i.e., a target device) may retrieve e-sim from a lower priority device (i.e., a source device) without any further action and/or authentication from the lower priority device. In case the target device 230 has lower priority than the source device 220, then user consent is needed to trigger the e-sim transfer. The user can modify the priorities as and when required. The e-sim related events can thus be handles in a user account consumer environment collectively for eUICCs registered to that user account. The user may log into the OEM entity 240 (SM-DS) and can use UI module 237 to update the device state table and device precedence graph. Further, registration of the devices may be performed using corresponding eUICC IDs after authentication. The authentication may be done, for instance, via authentication means such as one-time password (OTP), so that user can register new devices to the user account. In one embodiment, the priority module 246 may set a priority order and/or a hierarchy of the devices based on their priority to enable automated event based e-sim transfer.

The proxy module 245 may be configured to facilitate the OEM entity 240 to communicate with the MNO entity 250 on behalf of the source device 220 as a proxy, thereby providing a link between the source device 220 and the MNO entity 250. The proxy module 245 may use polling mechanism to execute triggered events. Thus, the proxy module 245 reduces MNO's burden by preventing individual polling and profiling of the source device 220.

The first DAG DLT module 247 at the OEM entity 240 may be configured to managing events and transactions in the OEM cloud (SM-DS). The second DAG DLT module 255 at the MNO entity 250 may be configured to managing events and transactions in the MNO cloud (SM-DP). Each of the OEM entity 240 and the MNO entity 250 may be associated with a decentralized architecture.

Once it is determined that the priority of the target device 230 is greater than the source device 220, the transactions related to the transfer of the e-sim are triggered. Details regarding the transactions related to the transfer of e-sim will now be described.

A first transaction indicative of a request to generate a new profile for the e-sim for the target device 230 and deletion of the e-sim from the source device 220 is triggered. Further, a second transaction indicative of a generation of the new profile and the transfer of the e-sim to the target device 230 is triggered. The first transaction may be recorded by the OEM entity 240 at a first ledger associated with the common OEM entity 240 and the second transaction may be recorded by the MNO entity 250 at a second ledger associated with the MNO entity 250.

The first transaction is tokenized at the first ledger based on ICCID of the e-sim and corresponding eUICCs (eUICC1 and eUICC2) of the target device 230 and the source device 220. Upon completion of tokenizing the first transaction at the OEM entity 240, the second transaction is tokenized at the second ledger. Further, a delete event is generated indicating deletion of the e-sim from the source device 220 by delinking the ICCID of the e-sim from the eUICC1 of the source device 220. Also, a generate event is generated indicating registration of the e-sim at the target device 230 by linking the ICCID of the e-sim to the eUICC2 of the target device 230.

A new profile is then generated for the e-sim including a profiling address for download and activation of the e-sim at the target device 230. The new profile is sent by the MNO entity 250 to the target device 230 via the common OEM entity 240 for download and activation at the target device 230, thereby completing the transfer of the e-sim. The new profile is downloaded at the target device 230, as mentioned above with respect to the profiling module 236. In some embodiments, the first and second ledger may be a common ledger.

An overview of the process to transfer the e-sim is as follows. The communication module 234 may inform the common OEM entity 240 about new priorities of the target device 230 and the source device 220. A DLT entry may be added at the first ledger and tokenized. The MNO entity 250 may be informed to generate the new profile and the transaction is tokenized at the second ledger. The MNO entity 250 then sends a link to the common OEM entity 240 (SM-DS) and the common OEM entity 240 pushes the profile address to the target device 230. The target device 230 downloads the link and activates the e-sim, thereby completing the transfer.

The events associated with the transfer of the e-sim may include e-sim registration, e-sim deletion, e-sim transfer, and the like. In case of the e-sim transfer event, the OEM entity 240 tokenizes the first transaction at the first ledger including event to delete ICCID from eUICC1 and event to register ICCID to eUICC2. Similarly, the second transaction (delete ICCID from eUICC1 and register ICCID to eUICC2) is tokenized at the second ledger at the MNO entity 250.

When an event for a respective eUICC (eUICC1 and/or eUICC2) and ICCID is triggered, an event is compiled as an entry to the first and second ledgers. The signed entry is securely transported to one or more nodes of the first and second ledgers to ensure authenticity of the event. Upon receipt of the entry, the transaction data is validated among the several nodes to verify that the transaction is correct and from an authorized source.

Further, at the nodes of the first and second ledgers, key and hash pairs are stored in a mesh graph structure. The key-hash pair or key value pairs may include Key—eUICC ID value and Hash—ICCID value, Key—ICCID value and Hash—eUICC value, or Key—ICCID value and Hash—OEM ID value. In order to change the key value pairs, DAG protocol consensus will have to be reached for each transaction. Both the OEM entity 240 and the MNO entity 250 communicate with each other to update regarding any transactions. The transactions are propagated across the OEM and MNO DAG graph nodes to produce blocks and execute a consensus among nodes.

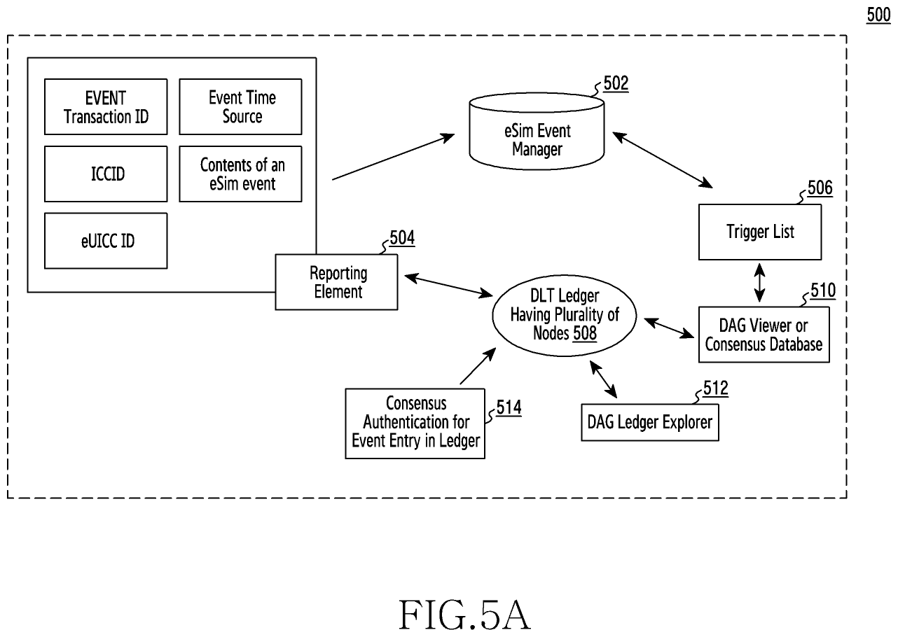

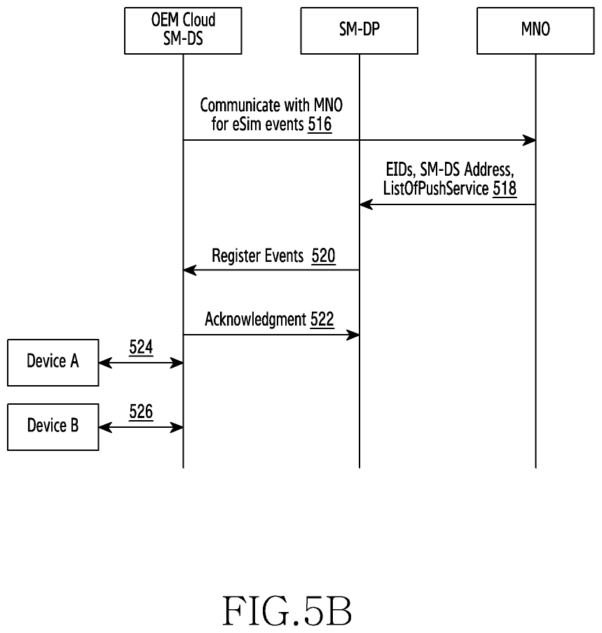

FIG. 5A illustrates an architecture for event management in an OEM entity and a MNO entity according to an embodiment of the disclosure.

Referring to FIG. 5A, an architecture 500 includes an event manager 502, a reporting element 504, a trigger list unit 506, a DLT ledger 508, a DAG database 510, a DAG explorer 512, and a consensus unit 514.

The reporting element 504 compiles and reports e-sim events information containing eUICC ID, ICCID, event ID, time stamps, and the like, to the event manager 502. The event manager 502 manages events of eUICCs (e.g., eUICC1 and eUICC2) and updates to trigger list unit 506 to set triggers of pushing events to eUICCs. The trigger list unit 506 maintains a list of e-sim event triggers set by the event manager 502 that are ready to be pushed to the respective eUICCs. Further, the DLT ledger 508 refers to the DAG graph structure of key value pairs. The DAG database 510 maintains event and e-sim ownership ledger of respective eUICCs and ICCIDs. The consensus unit 514 authenticates ownership change transactions via consensus of nodes.

The source device 220 and the target device 230 periodically poll the OEM entity 240 (SM-DS) to retrieve events pending for eUICC1 and eUICC2 and the OEM entity 240 pushes the events to the respective devices. The source device 220 and the target device 230 detect the presence of respective events based on polling of events at the common OEM entity 240 and thereafter process the respective events.

In some embodiments, the transactions are tokenized at the nodes of the OEM entity 240 and the MNO entity 250. Transactions are tokenized at the OEM entity 240 and the MNO entity 250 regardless of availability of the source device 220. The DAG nodes have a faster transaction speed as DAG nodes reach consensus significantly faster when compared to blockchain networks. Further, DAGs are more scalable than blockchain networks which is beneficial for e-sim transactions in view of rise of e-sim adoption. Moreover, DAG transactions have lower costs and computing power.

In some embodiments, the MNO entity 250 communicates with the OEM entity 240 regarding pushing of the MNO profiling address to the target device 230 and registers the transaction on the second ledger by updating the key value pairs for the target device 230 (eUICC2). The profiling address may be a unique code that identifies a remote server used to manage e-sims. Further, the OEM entity 240 on receipt of the event registers the transaction on the first ledger by updating the key value pairs for the target device 230 (eUICC2) and generates a push service event for the target device 230 to push the MNO profiling address to the target device 230.

Further, smart contracts are used between the source device 220 and the target device 230 to execute the transfer by deleting from the source device 220 and registering with the target device 230 in a closed loop. Accordingly, when all conditions associated with the transfer of the e-sim are fulfilled, the first and second transactions are executed which provide a fail-proof system.

FIG. 5B illustrates a sequence diagram for SM-DS as device proxy for eSIM events, according to an embodiment of the disclosure.

Referring to FIG. 5B, At operation 516, the OEM cloud (SM-DS) communicates with MNO for eSIM events for each eUICC. In an embodiment of the disclosure, profile providing servers may communicate with devices via the OEM cloud (SM-DS) and hence profile providing servers may follow the sequence of messages as per their interaction with cloud on behalf of the devices. If event is eSim transfer, DAG DLT at OEM cloud may be tokenized in ledger of transaction of ICCID from source to target. In an embodiment of the disclosure, Event 1 corresponds to delete ICCID 1 from eUICC A. Further, Event 2 corresponds to register ICCID 1 to eUICC B. At operation 518, the MNO shares the EIDs, SM-DS address, and a list of push service (eSIM events to be pushed to eUICC) to the SM-DP. If event is eSim transfer, DAG DLT at MNO may be tokenized in ledger of transaction of ICCID from source to target. In an embodiment of the disclosure, Event 1 corresponds to delete ICCID 1 from eUICC A. Further, Event 2 corresponds to register ICCID 1 to eUICC B.

Further, at operation 520, the SM-DP register events (EIDs, Profile address, eventID, and list of push services). At operation 522, the SM-DP receives an acknowledgement on the registration of the events. Further, at operations 524 and 526, device A may periodically poll SM-DS when ON to retrieve events pending for eUICC A (likewise for device B). In an embodiment of the disclosure, the SM-DS may push respective events to respective eUICCs.

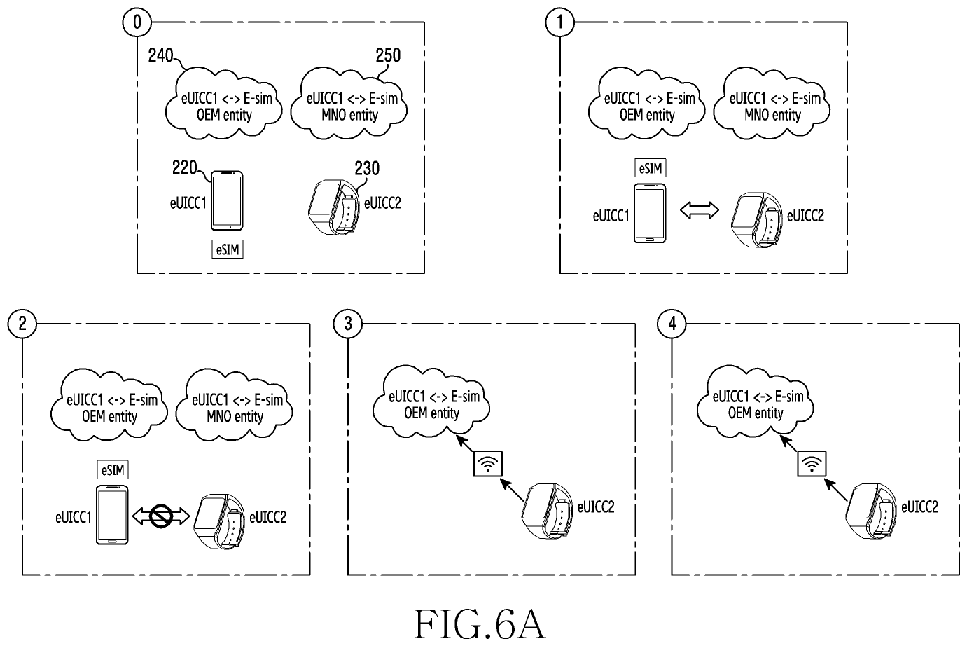

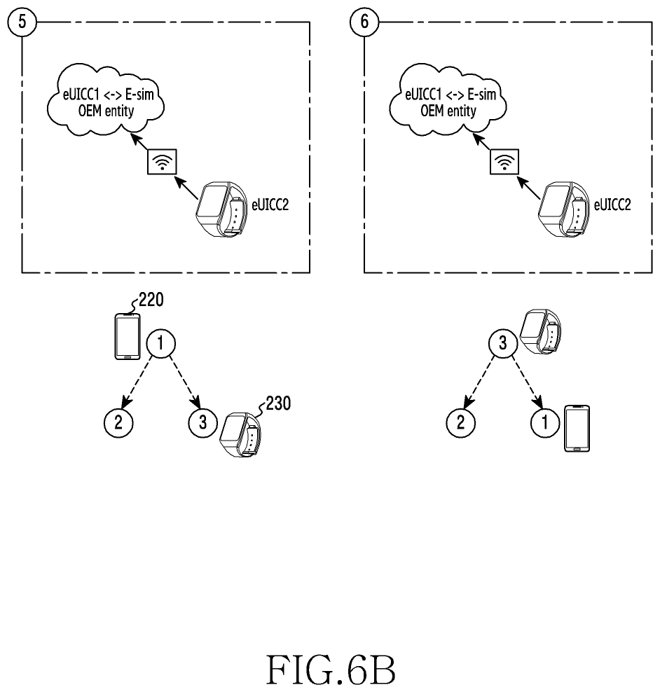

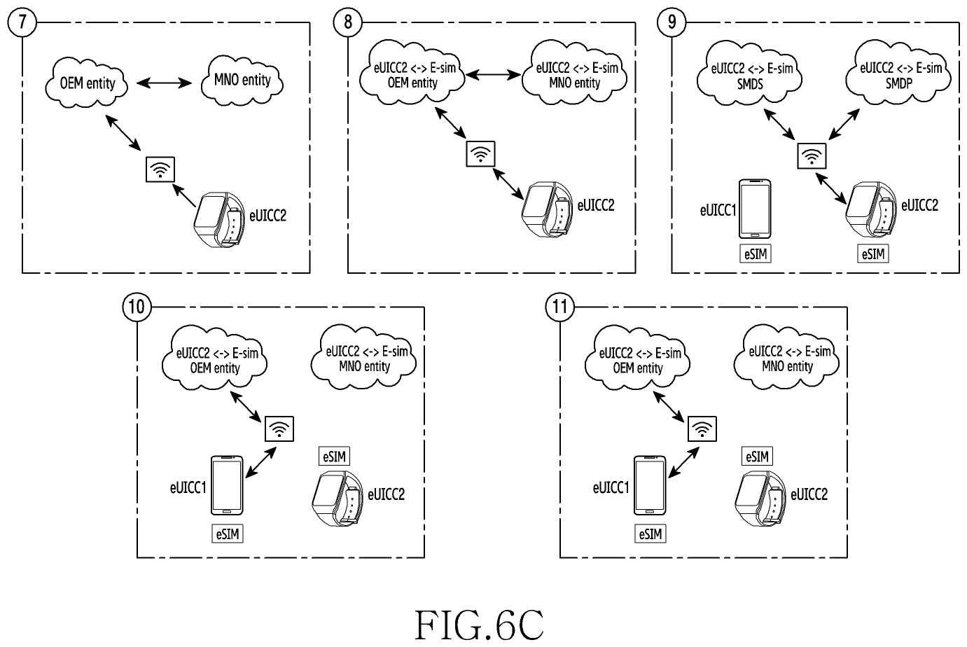

FIGS. 6A, 6B, and 6C illustrate a stepwise sequence flow for transfer of an e-sim from a source device to a target device according to various embodiments of the disclosure.

Steps 0-4 are shown in FIG. 6A, steps 5-6 are shown in FIG. 6B, and steps 7-11 are shown in FIG. 6C.

Referring to FIGS. 6A to 6C, at step 0, the eUICC1 of the source device 220 is mapped to the e-sim (ICCID) at the OEM entity 240 and the MNO entity 250. At step 1, the detection module 233 detects the state of the target device 230 with respect to the source device 220. For instance, proximity of the target device 230 with respect to the source device 220 may be checked. At step 2, the detection module 233 may detect that a pre-determined criteria is met (for instance, the source device 220 is a threshold distance away from the target device 230 for a set period of time) and determine that transfer of e-sim is required. At step 3, the detection module 233 requests the communication module 234 to connect with the OEM entity 240 via the connection module 235.

At step 4, the UI module 237 may enable the user to login to the OEM entity 240 to access the device priority data unit 248, for instance, the device state table and the device precedence graph. At step 5, the priority module 246 checks the priority of the target device 230 with respect to the source device 220. In case the target device 230 has a greater priority than the source device 220, then the e-sim transfer can be triggered automatically. If not, then user content may be needed to trigger the e-sim transfer. In the present example, the priority of the target device 230 may be lesser than the source device 220. At step 6, the user may update the priorities of the target device 230 with respect to the source device 220.

At step 7, the proxy module 245 interacts on behalf of the devices with the MNO entity 250 and facilitates push-based e-sim profiling on the devices. As described above, the OEM entity 240 and the MNO entity 250 have a decentralized architecture, which also helps in recovery procedures. At step 8, the first DAG DLT module 247 and the second DAG DLT module 255 initiate the transactions and link the e-sim to the eUICC2 of the target device 230. Further, the MNO entity 250 notifies the OEM entity 240 about the confirmation, requests to delete the e-sim from the eUICC1, and shares the MNO provisioning server address to download the new profile. The use of DLT at both OEM entity 240 and the MNO entity 250 makes the process fail safe, and even if the process fails at any step it can be recovered automatically.

At step 9, the profiling module 236 downloads and installs the e-sim from the MNO entity 250. At step 10, the OEM entity 240 facilitates deletion of the e-sim from the source device 220. At step 11, camping of the e-sim on eUICC1 is denied by the network as the MNO entity 250 (SM-DP) has entry of e-sim with eUICC2.

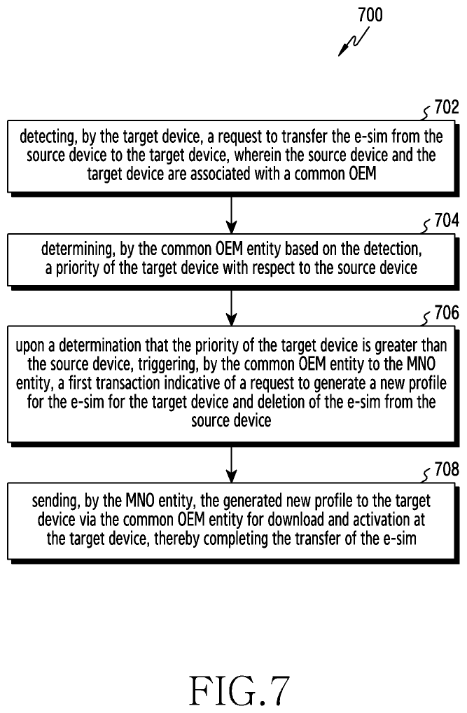

FIG. 7 illustrates a process flow of a method for transferring an e-sim from a source device to a target device, according to an embodiment of the disclosure.

Referring to FIG. 7, the steps of a method 700 may be performed by the system 210, for instance, by the respective processors and modules of the target device 230, the OEM entity 240, and the MNO entity 250.

At operation 702, the method 700 includes detecting, by the target device, a request to transfer the e-sim from the source device to the target device, wherein the source device and the target device are associated with a common OEM.

At operation 704, the method 700 includes determining, by the common OEM entity based on the detection, a priority of the target device with respect to the source device.

At operation 706, the method 700 includes, upon a determination that the priority of the target device is greater than the source device, triggering, by the common OEM entity to the MNO entity, a first transaction indicative of a request to generate a new profile for the e-sim for the target device and deletion of the e-sim from the source device.

At operation 708, the method 700 includes sending, by the MNO entity, the generated new profile to the target device via the common OEM entity for download and activation at the target device, thereby completing the transfer of the e-sim.

While the above discussed steps in FIG. 7 are shown and described in a particular sequence, the steps may occur in variations to the sequence in accordance with various embodiments. Further, a detailed description related to the various steps of FIG. 7 is already covered in the description related to FIGS. 2A, 2B, 3, 4, 5A, 5B, and 6A to 6C and is omitted herein for the sake of brevity.

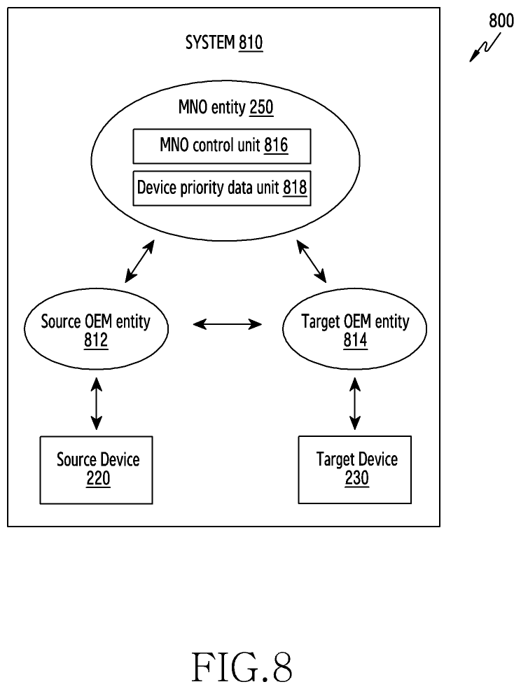

FIG. 8 illustrates an overview of an environment comprising a system for transfer of an e-sim from a source device to a target device according to an embodiment of the disclosure.

Referring to FIG. 8, an environment 800 comprising a system 810 for transfer of e-sim from the source device 220 to the target device 230 is illustrated. The system comprises the MNO entity 250, the source device 220, and the target device 230. The source device 220 is associated with a source OEM while the target device 230 is associated with a target OEM. The target OEM is different from the source OEM. The system 810 additionally comprises a source OEM entity 812 for the source OEM and a target OEM entity 814 for the target OEM.

The details regarding the components of the source device 220, the target device 230, and the MNO entity 250 have been detailed with reference to FIG. 2B and the details are not repeated for sake of brevity. Further, the source OEM entity 812 and the target OEM entity 814 may be similar to the common OEM entity 240 as explained with reference to FIG. 2B and the same is not repeated for sake of brevity.

The source OEM entity 812 and the target OEM entity 814 may be associated with Subscription Managed Discovery Service (SM-DS) and the MNO entity 250 may be associated with Subscription Manager Data Preparation (SM-DP). The source device 220 may be associated with Embedded Universal Integrated Circuit Cards (eUICC1) and the second device may be associated with eUICC2. The e-sim may be associated with Integrated Circuit Card Identifier (ICCID).

In addition to the details provided for the MNO entity 250 with respect to FIG. 2B, the MNO entity 250 with respect to FIG. 8 may additionally include an MNO control unit 816 and a database configured to store a device priority data unit 818.

The device priority data unit 818 may indicate corresponding eUICC identifiers and corresponding priorities of the source device 220 associated with the source OEM, the target device 230 associated with the target OEM, and one or more additional devices with respect to each other. The source device 220, the target device 230, and the one or more additional devices are registered at the device priority data unit 818 using corresponding eUICCs via a user account. The user may access the device priority data unit 818 via the user account. Further, the user may register the devices, such as the source device 220 and the target device 230 at the device priority data unit 818. Additionally, the user may update the device priority data unit 818, such as, to modify the priorities of the devices.

In an embodiment, the source OEM entity 812 may store information for the devices related to the source OEM while the target OEM entity 814 may store information for the devices related to the target OEM. At the MNO entity 250, in particular at the device priority data unit 818, a tree hierarchy of priorities can be established for seamless and efficient inter-OEM e-sim transfers. A chain of trust is established for e-sim ownership and to facilitate collaboration between entities of different OEMs.

At the MNO entity 250, the user can register devices linked to different OEMs and trigger e-sim transfers from source device of source OEM to the target device of target OEM. The MNO control unit 816 may be configured to instruct the MNO provisioning servers to interact with respective OEM entities for processing the e-sim transfers.

Further, a DAG based decentralized ledger for e-sim transfer transactions is essential for establishing trust and security related to ownership of the e-sim till the e-sim is successfully transferred. The ledger may be associated with the MNO entity 250, the source OEM entity 812, and/or the target OEM entity 814. In some embodiments, the source OEM entity 812, the target OEM entity 814, and the MNO entity 250 are decentralized and all transactions will be tokenized on DAG based on smart contracts. Each node in the DAG graph may have tokenized data of key-value pairs, which includes ICCID ID, eUICC ID, as well as OEM ID. Moreover, the transfer of e-sim may be carried out via smart contracts where both the OEM ID and the eUICC ID are updated in the ledger. The source OEM entity 812 and the target OEM entity 814 may be configured to provide discovery services to the corresponding eUICCs and support in push mechanism-based e-sim transfer and profiling.

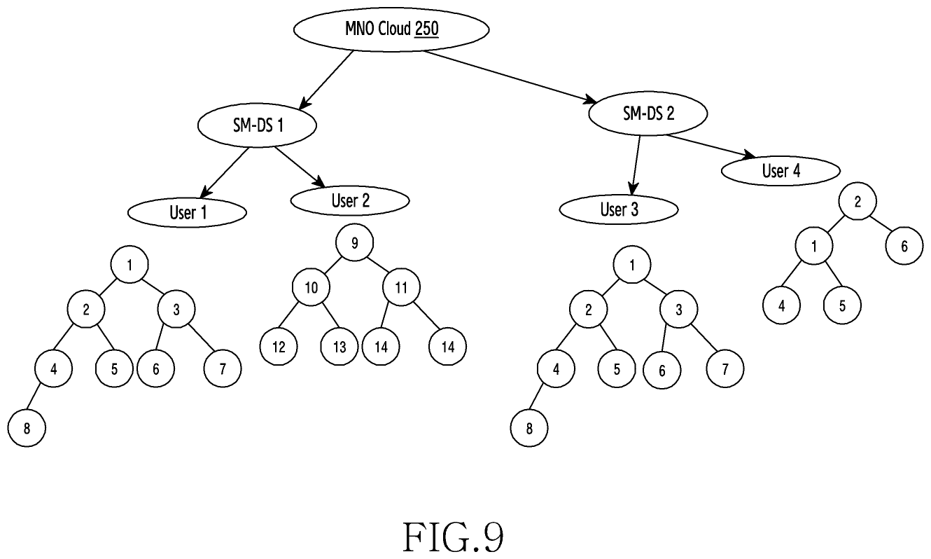

FIG. 9 illustrates a tree-based hierarchy stored at a device priority data unit according to an embodiment of the disclosure.

Referring to FIG. 9, each ICCID (e-sim) may be mapped to corresponding OEM ID (SM-DS ID) and eUICC for the device in the corresponding OEM. The chain of trust between different SM-DS (OEMs) is established based on the DAG. FIG. 9 shows link of eUICC<->ICCID of source OEM (SM-DS 1) and link of eUICC<->ICCID of target OEM (SM-DS 2).

Referring again to FIG. 8, for transfer of the e-sim from the source device 220 to the target device 230, a request to transfer the e-sim is received from the user via the MNO control unit 816. The MNO control unit 816 requests the target OEM entity 814 to register the e-sim at the target OEM. Further, the MNO control unit generates a new profile of the e-sim and sends the generated new profile to the target device 230 via the target OEM entity 814. In an embodiment, a delete event is transacted at the MNO and a source OEM. Thereafter, after receiving confirmation from the source OEM, a registration event is triggered by the MNO at the target OEM. Further, upon successful registration, a register event is updated at the MNO and e-sim profile download address is delivered to the target OEM. The target device 230 may then download and activate the e-sim.

The registration of the e-sim may be tokenized at a target ledger, i.e., the DAG ledger by delinking the ICCID of the e-sim from the SM-DS of the source OEM and eUICC of the source device 220 and linking the ICCID of the e-sim to the SM-DS of the target OEM and eUICC of the target device 230. Further, prior to the registration of the e-sim, the deletion of the e-sim from the source OEM may be tokenized at a source ledge. The generation of the new profile is recorded at the MNO ledger, i.e., DAG ledger. Further, each of the delete and register event may be tokenized at a MNO cloud ledger.

A delete event is generated by the MNO control unit 816. The delete event indicates deletion of the e-sim from the source device by delinking the ICCID of the e-sim from the SM-DS of the source OEM and the eUICC of the source device. Further, the delete event is sent by the MNO control unit 816 to the source OEM entity 812. When the source device 220 detects presence of the delete event at the source OEM entity, the e-sim is deleted.

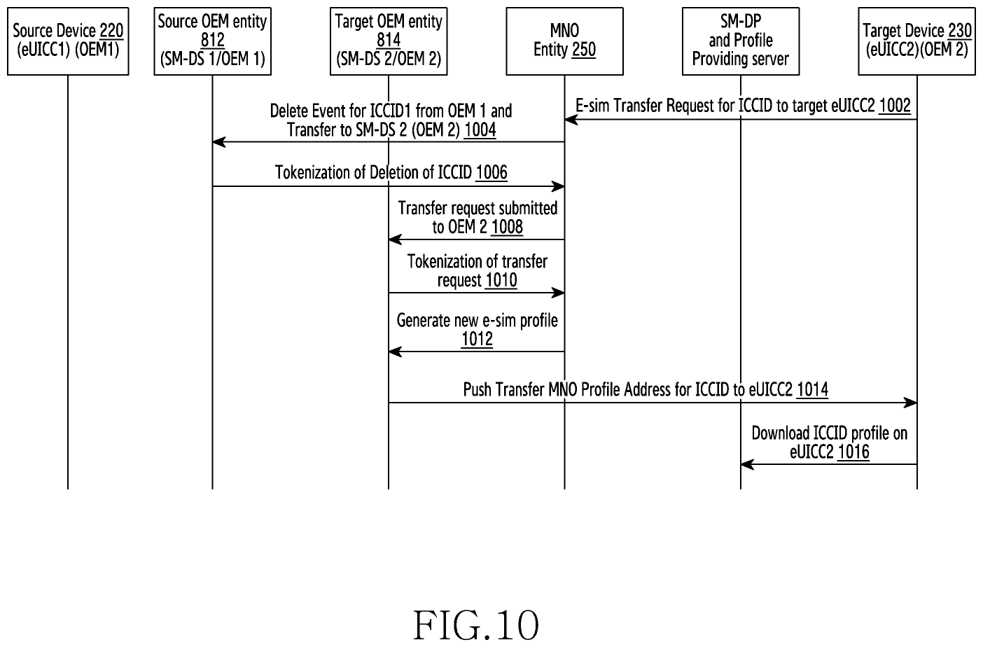

FIG. 10 illustrates a line diagram illustrating a process for inter-OEM transfer of an e-sim from a source device (eUICC1) to a target device (eUICC2) according to an embodiment of the disclosure.

Referring to FIG. 10, at operation 1002, a transfer request may be sent for the ICCID (e-sim). The request may be submitted by the user via the user account associated with the MNO entity 250. At operation 1004, the MNO entity 250 generates a delete event for the ICCID from source OEM (OEM 1 or SM-DS 1) and transfer to the target OEM (OEM 2 or SM-DS 2). The MNO entity 250 sends the delete event to the source OEM entity 812.

At operation 1006, tokenization of the delete event is completed at the DAG ledger of the source OEM entity 812. The MNO entity 250 is then updated regarding the tokenization. At operation 1008, the MNO entity 250 sends a transfer request to the target OEM entity 814. At operation 1010, tokenization of the transfer request (ICCID1<->eUICC2) is completed for addition of ICCID to the target OEM and the target device 230. At the DAG ledger at the MNO entity 250, the transaction ICCID1<->OEM 2<->eUICC2 is also tokenized. All the transactions are done via DAG based smart contracts and the nodes of the OEM entities and the MNO entity propagate information with each other to maintain chain of trust.

At operation 1012, new e-sim profile (new MNO profile provisioning address) is generated for the ICCID and sent to the target OEM entity 814 for pushing mechanism to the target device 230. At operation 1014, the target OEM entity 814 pushes the MNO profile provisioning address to the target device 230. At operation 1016, the target device 230 downloads the ICCID profile from the SM-DP and profile providing server.

Further, no communication is required from the source device 220 for transfer. The source device 220 may be lost or unavailable. As soon as source device 220 is available, the source device 220 may poll the source OEM entity 812 and retrieve the delete event. The source device 220 may then delete the e-sim. In any case, the transaction is already updated and the source device 220 cannot access the ICCID.

In some embodiments, a third-party discovery server may be provided that collaborates with different OEMs to monitor the e-sim transactions. The third-party discovery server may perform one or more operations of the MNO control unit 816, such as, operations to store the device priority data unit 818 at the third-party discovery server, update the device priority data unit 818, monitor the transfer of e-sim from the source device to the target device, perform transfer transactions and maintain the DAG ledger, and communicate with the target OEM entity 814 and the source OEM entity 812. It is appreciated that in such an embodiment, the details provided above with respect to the MNO entity 250 is applicable for the third-party discovery server as well. In an embodiment, the third party discovery server may also follow a sequence similar to MNO for performing e-sim transfer. Specifically, initially a delete event is transacted at the third party discovery server and a source OEM. Thereafter, after receiving confirmation from the source OEM, a registration event is triggered by the third party discovery server at the target OEM. Further, upon successful registration, a register event is updated at the third party discovery server and e-sim profile download address is delivered to the target OEM.

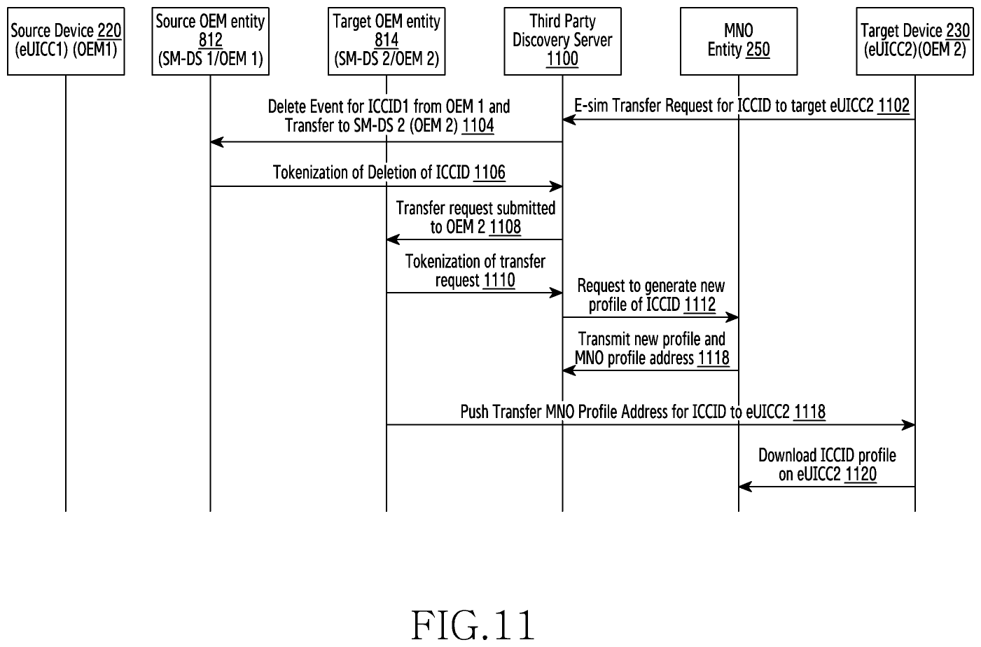

FIG. 11 illustrates a line diagram illustrating a process for inter-OEM transfer of an e-sim from a source device (eUICC1) to a target device (eUICC2) using a third-party discovery server according to an embodiment of the disclosure.

Referring to FIG. 11, in a third-party discovery server 1100, at operation 1102, a transfer request may be sent for the ICCID (e-sim) for transfer to eUICC2. The request may be submitted by the user via the user account associated with the third-party discovery server 1100. At operation 1104, the third-party discovery server 1100 generates a delete event for the ICCID from source OEM (OEM 1 or SM-DS 1) and transfer to the target OEM (OEM 2 or SM-DS 2). The third-party discovery server 1100 sends the delete event to the source OEM entity 812.

At operation 1106, tokenization of the delete event is completed at the DAG ledger of the source OEM entity 812. The third-party discovery server 1100 is then updated regarding the tokenization. At operation 1108, the third-party discovery server 1100 sends a transfer request to the target OEM entity 814. At operation 1110, tokenization of the transfer request (ICCID1<->eUICC2) is completed for addition of ICCID to the target OEM and the target device 230. At the DAG ledger at the third-party discovery server 1100, the transaction ICCID1<->OEM 2<->eUICC2 is also tokenized. All the transactions are done via DAG based smart contracts and the nodes of the OEM entities and the third-party discovery server 1100 propagate information with each other to maintain chain of trust.

At operation 1112, the third-party discovery server 1100 request the MNO entity 250 to generate new profile for ICCID for the eUICC2. At operation 1114, the MNO entity 250 transmits the new profile and MNO profile address to the third-party discovery server 1100.

At operation 1116, the third-party discovery server 1100 transmits the new MNO profile address to the target OEM entity 814 for pushing mechanism to the target device 230. At operation 1118, the target OEM entity 814 pushes the MNO profile address to the target device 230. At operation 1120, the target device 230 downloads the ICCID profile from the MNO entity 250 (in particular, the SM-DP and profile providing server). As soon as source device 220 is available, the source device 220 may poll the source OEM entity 812 and retrieve the delete event. The source device 220 may then delete the e-sim. In any case, the transaction is already updated and the source device 220 cannot access the ICCID.

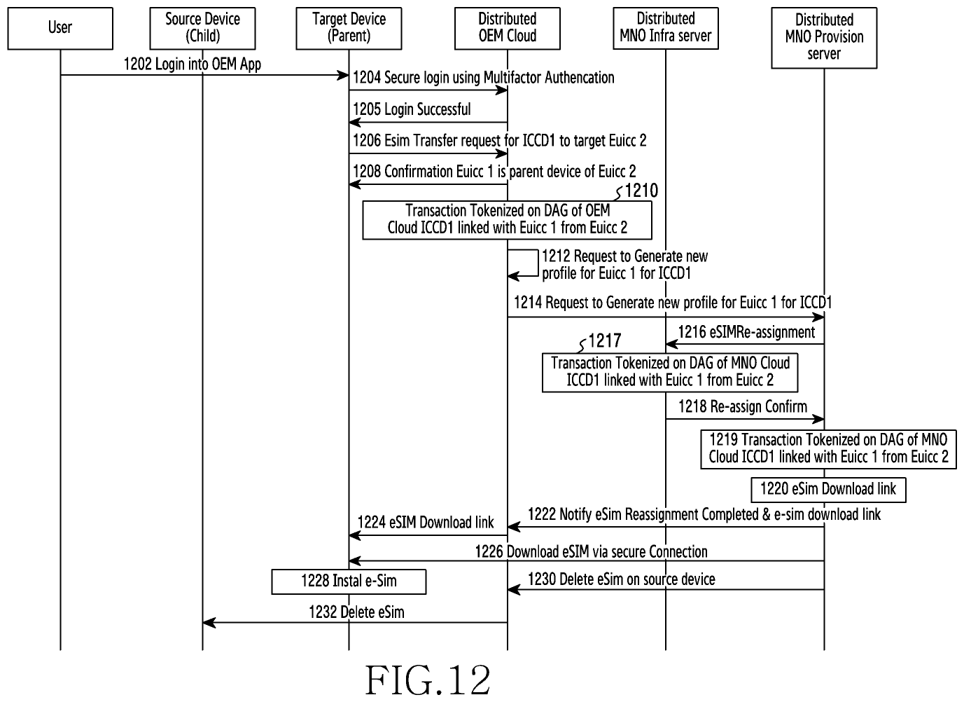

FIG. 12 illustrates another line diagram illustrating a process for intra-OEM transfer of an e-sim from a source device to a target device, according to an embodiment of the disclosure.

Referring to FIG. 12, at operation 1202, the user logins into the OEM application. In an embodiment of the disclosure, the source eUICC does not have to be near target, or powered on, or available to communicate with cloud or MNO. Further, at operation 1204, the target device performs secure login using multi-factor authentication. At operation 1205, login is successful. At operation 1206, the target device shares the ESIM transfer request for ICCD 1 to target EUICC 2. Furthermore, at operation 1208, the distributed OEM cloud confirms that the EUICC 1 is parent device of EUICC 2.

Further, at operation 1210, transaction tokenized on DAG of OEM cloud ICCD 1 is linked with EUICC 1 from EUICC 2. At operation 1212, the distributed OEM cloud creates a request to generate a new profile for EUICC 1 for ICCD 1. In an embodiment of the disclosure, DAG DLT at OEM cloud (SM-DS) may be tokenized in ledger of transaction of ICCID 1 from source to target. Further, at operation 1214, the created request is shared with distributed MNO provision server. At operation 1216, e-SIM reassignment is performed. In an embodiment of the disclosure, DAG DLT at MNO may tokenize in ledger of transaction of ICCID 1 from source to target. At operation 1217, transaction tokenized on DAG of MNO cloud ICCF1 is linked with EUICC 1 from EUICC 2. At operation 1218, re-assignment is confirmed. Further, at operation 1219, transaction tokenized on DAG of MNO cloud ICCD 1 is linked with EUICC 1 from EUICC 2.

Furthermore, at operation 1220, eSIM download link is obtained. At operation 1222, the distributed MNO provision server notifies the distributed OEM cloud about the eSIM reassignment completion and e-SIM download link. At operation 1224, the distributed OEM cloud shares the eSIM download link to the target device. Further, at operation 1226, the target device downloads eSIM via secure connection. The target device installs the eSIM at operation 1228. In an embodiment of the disclosure, the DAG/blockchain based Smart contracts are used to execute deletion from source and registration on target in a closed loop. If all the conditions are fulfilled, the process may be completed, else the process may not be executed. In an embodiment of the disclosure, a push mechanism is incorporated without any limitations. At operations 1230 and 1232, eSIM is deleted from the source device.

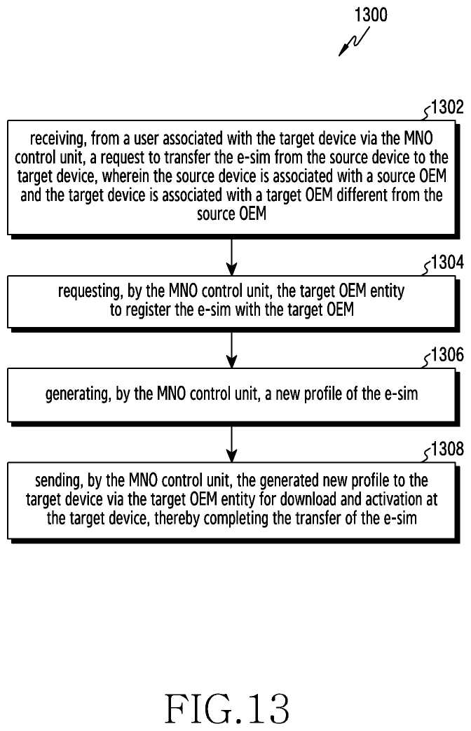

FIG. 13 illustrates a process flow of a method for transferring a e-sim from a source device to a target device, according to an embodiment of the disclosure.

In one embodiment, the steps of the method 1300 may be performed by the system 810, for instance, by the respective processors and modules of the target device 230, the source and target OEM entities 812, 814, and the MNO entity 250/third-party discovery server.

Referring to FIG. 13, in a method 1300, at operation 1302, the method 1300 includes receiving, from a user associated with the target device via the MNO control unit 816, a request to transfer the e-sim from the source device 220 to the target device 230, wherein the source device 220 is associated with the source OEM and the target device 230 is associated with the target OEM different from the source OEM.

At operation 1304, the method 1300 includes requesting, by the MNO control unit 816, the target OEM entity 814 to register the e-sim with the target OEM. At operation 1306, the method 1300 includes generating, by the MNO control unit 816, a new profile of the e-sim. At operation 1308, the method 1300 includes sending, by the MNO control unit 816, the generated new profile to the target device 230 via the target OEM entity 814 for download and activation at the target device 230, thereby completing the transfer of the e-sim.

While the above discussed steps in FIG. 13 are shown and described in a particular sequence, the steps may occur in variations to the sequence in accordance with various embodiments. Further, a detailed description related to the various steps of FIG. 13 is already covered in the description related to FIGS. 8 to 11 and is omitted herein for the sake of brevity.

In an use case, the described system and method can be used in case of a lost source device. The user can login to the OEM entity and initiate e-sim transfer to a new device. Further, the user can update the hierarchy and priorities. The user can also mark the lost eUICC as invalid for any future e-sim transactions on it which enhances device security.

In another use case, the described systems and methods can be used to bundle multiple e-sim transfers in multiple devices using a single UI. The user can login to OEM entity and trigger three transactions at once. The user can seamlessly decide on e-sim configurations of all devices in the ecosystem. The e-sim transactions are collectively dealt in a user account. Considering a scenario where starting configuration of device and e-sim is:
E1<->I1
E2<->I2
E3<->I3

Further, the target configuration is:
E1<->I3
E2<->I1
E3<->I2

As per conventional mechanisms, the user would have to do multiple transfers, i.e., transfer I1 from E1 to E2, then transfer I2 from E2 to E3, then transfer I3 from E3 to E1. These include three transactions by taking two devices at a time which is cumbersome, inefficient and requires proximity and availability of all devices. However, as per the disclosed methods and systems, the user can login to the OEM entity and set target configurations of the devices. Based on configurations, the device priorities will be set and the OEM entity may trigger three events of e-sim transfers to the MNO entity. Each transaction will be processed and tokenized at the ledgers. The OEM entity will send the respective MNO address to each device after receiving three events from the MNO entity for each e-sim.

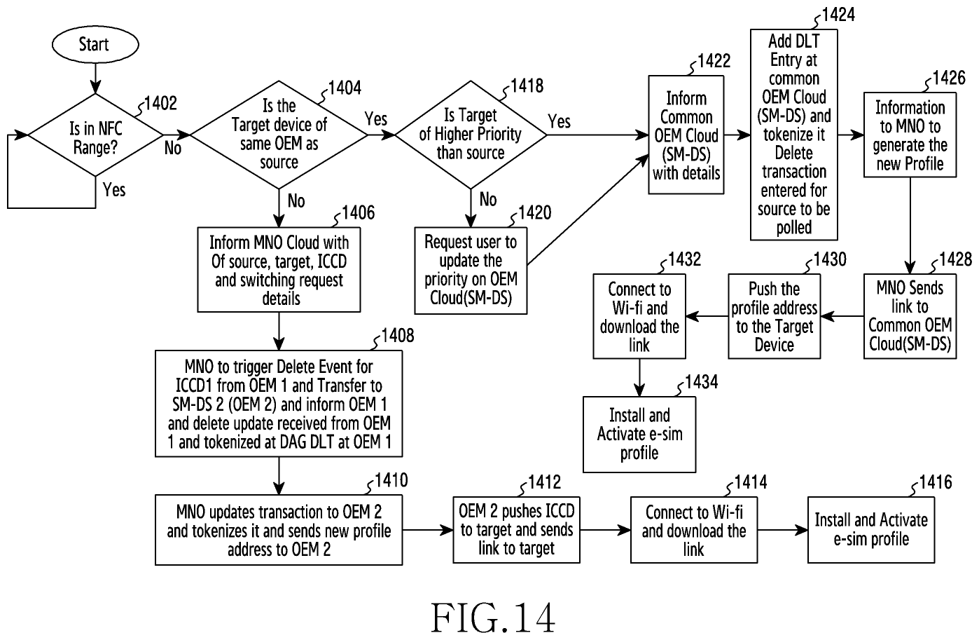

FIG. 14 illustrates a detailed process flow of a method for transferring an e-sim from a source device to a target device, according to an embodiment of the disclosure.

Referring to FIG. 14, at operation 1402, the system determined if NFC is in range. At operation 1404, if the output of step is no, the system determines if the target device of same OEM is the source. If the output of operation 1404 is no, the MNO cloud is informed about the source, target, ICCD and switching request details at operation 1406. In an embodiment of the disclosure, the user interface (UI) may be provided by the MNO cloud to set it. At operation 1408, the system triggers the MNO to delete event for ICCD 1 from OEM 1, transfer to SM-DS 2 (OEM 2), inform OEM 1, and delete update received from OEM 1 and tokenized at DAG DLT at OEM 1. At operation 1410, the MNO updates transaction to OEM 2 and tokenizes it and sends new profile address to OEM 2.

At operation 1412, OEM 2 pushes ICCD to target and sends link to the target device. At operation 1414, the target device connects to Wi-fi and download the link. At operation 1416, the target device installs and activates the e-sim profile. Further, if the output of operation 1404 is no, it is determined if the target is of higher priority than the source, at operation 1418. In an embodiment of the disclosure, switching route is automated as per priorities set by the user. If the output of operation 1418 is no, the user is requested to update the priority on OEM Cloud (SM-DS) in operation 1420. In an embodiment of the disclosure, UI may be provided by OEM Cloud (SM-DS) to set it.

If the output of operation 1418 is yes, Common OEM Cloud (SM-DS) is informed with details, at operation 1422. At operation 1424, DLT entry is added at common OEM Cloud (SM-DS) and tokenized. Further, the transaction entered for source to be polled is deleted. At operation 1426, information is shared with MNO to generate the new profile. At operation 1428, MNO Sends link to Common OEM Cloud (SM-DS). Further, at operation 1430, the profile address is pushed to the target device. Further, at operation 1432, the target device connects to Wi-Fi and download the link. At operation 1434, the target device installs and activates the e-sim profile.

The disclosure provides for various technical advancements based on the key features discussed above. The presently disclosed methods and systems provide a distributed MNO server and OEM server architecture that enables seamless event-based e-sim transfer from source device to target device. A hierarchy-based structure at the OEM cloud is used with device priorities. Higher-priority devices can trigger event-based automatic e-sim switching. Further, the methods and systems work for inter-OEM and intra-OEM cases. Different OEM's entities can interact with each other to have inter OEM e-sim transfer.

The methods and systems will provide advancement for operator-OEM collaboration where MNOs can offload the e-sim transfer burden on OEM entities, which will help facilitate faster and more secure e-sim transfers. OEM entity will handle e-sim events in a user account consumer environment collectively for eUICCs registered to that user account.

The proposed methods and systems work even when the source device is lost or unavailable. There is not requirement for short term proximity. Further, there is no communication necessity or dependency between source and target devices.

Additionally, the transactions executed by DAG based smart contracts on a closed loop, thereby ensuring that the transfer gets completed only when all the conditions are fulfilled, else the transfer is not executed.

While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

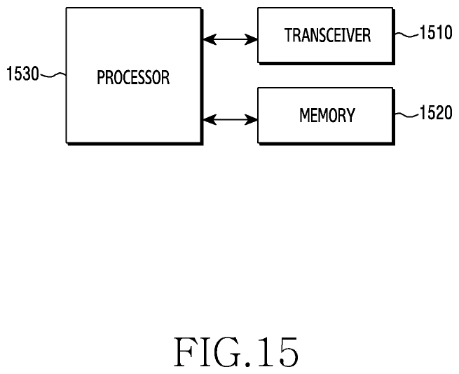

FIG. 15 illustrates a block diagram of a user equipment (UE or terminal) according to an embodiment of the disclosure.

Referring to FIG. 15, the UE according to an embodiment may include a transceiver 1510, memory 1520, and a processor 1530. The transceiver 1510, the memory 1520, and the processor 1530 of the UE may operate according to a communication method of the UE described above. However, the components of the UE are not limited thereto. For example, the UE includes more or fewer components than those described above. In addition, the processor 1530, the transceiver 1510, and the memory 1520 may be implemented as a single chip. Also, the processor 1530 may include at least one processor. Furthermore, the UE of FIG. 15 corresponds to the current device or the new device of FIG. 1, source device 220 or target device 230 of FIG. 2A, 2B, 3, 6A to 6C, 8, 10, 11, or 12.

The transceiver 1510 collectively refers to a UE receiver and a UE transmitter, and may transmit/receive a signal to/from a base station or a network entity. The signal transmitted or received to or from the base station or a network entity may include control information and data. The transceiver 1510 may include a radio frequency (RF) transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the UE. Also, the memory 1520 may store control information or data included in a signal obtained by the UE. The memory 1520 may be a storage medium, such as read-only memory (ROM), random access memory (RAM), a hard disk, a compact disc (CD)-ROM, and a digital versatile disc (DVD), or a combination of storage media.

The processor 1530 may control a series of processes such that the UE operates as described above. For example, the transceiver 1510 receives a data signal including a control signal transmitted by the base station or the network entity, and the processor 1530 may determine a result of receiving the control signal and the data signal transmitted by the base station or the network entity.

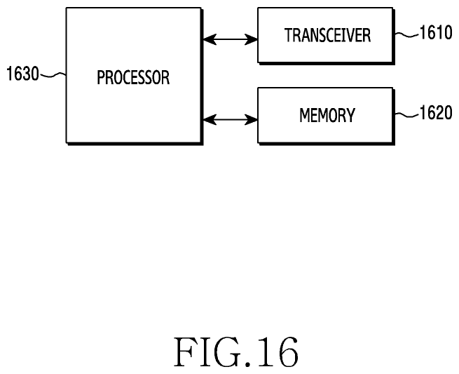

FIG. 16 illustrates a block diagram of a base station (BS) according to an embodiment of the disclosure.

Referring to FIG. 16, the base station according to an embodiment may include a transceiver 1610, memory 1620, and a processor 1630. The transceiver 1610, the memory 1620, and the processor 1630 of the base station may operate according to a communication method of the base station described above. However, the components of the base station are not limited thereto. For example, the base station includes more or fewer components than those described above. In addition, the processor 1630, the transceiver 1610, and the memory 1620 may be implemented as a single chip. Also, the processor 1630 may include at least one processor.

The transceiver 1610 collectively refers to a base station receiver and a base station transmitter, and may transmit/receive a signal to/from a terminal (UE) or a network entity. The signal transmitted or received to or from the terminal or a network entity may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the base station. Also, the memory 1620 may store control information or data included in a signal obtained by the base station. The memory 1620 may be a storage medium, such as read-only memory (ROM), random access memory (RAM), a hard disk, a CD-ROM, and a DVD, or a combination of storage media.

The processor 1630 may control a series of processes such that the base station operates as described above. For example, the transceiver 1610 receives a data signal including a control signal transmitted by the terminal, and the processor 1630 determines a result of receiving the control signal and the data signal transmitted by the terminal.

The methods according to the embodiments described in the claims or the detailed description of the disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the disclosure. Another storage device on the communication network may also be connected to the apparatus performing the embodiments of the disclosure.

In the afore-described embodiments of the disclosure, elements included in the disclosure are expressed in a singular or plural form according to the embodiments. However, the singular or plural form is appropriately selected for convenience of explanation and the disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment includes any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A target device, comprising:
a transceiver;
at least one processor; and
at least one memory storing instructions,
wherein the instructions, when executed by the at least one processor, cause the target device to:
detect a request to transfer an embedded subscriber identity module (e-sim) from a source device to the target device, wherein the source device and the target device are associated with a common original equipment manufacturer (OEM) entity, and
receive, from a mobile network operator (MNO) entity, a new profile for the e-sim for download and activation at the target device, thereby completing the transfer of the e-sim,
wherein a determination that the target device is prior to the source device is performed by the common OEM entity, and
wherein a first transaction indicative of a request to generate the new profile for the e-sim for the target device and deletion of the e-sim from the source device is triggered by the common OEM entity upon the determination.

2. The target device of claim 1,
wherein the first transaction at a first ledger associated with the common OEM entity is recorded by the common OEM entity,
wherein a second transaction indicative of a generation of the new profile and the transfer of the e-sim to the target device is triggered by the MNO entity, and
wherein the second transaction at a second ledger associated with the MNO entity is recorded by the MNO entity.

3. The target device of claim 1, wherein the instructions, when executed by the at least one processor, cause the target device to:
detect, at a private cloud associated with a user of the target device and the source device, a transfer event indicating that a transfer to the target device is required,
determine whether the transfer event fulfills a predetermined criteria, and
detect the request to transfer the e-sim upon a determination that the transfer event fulfills the predetermined criteria.

4. The target device of claim 1, wherein the instructions, when executed by the at least one processor, cause the target device to:
receive a user request indicative of initiation of the transfer of e-sim from the source device to the target device.

5. The target device of claim 1, wherein the determination is based on a database of the common OEM entity, the database storing a device priority data unit indicating a priority of the source device, the target device, and one or more additional devices with respect to each other, corresponding identifiers and states of the source device, the target device, and one or more additional devices.

6. The target device of claim 1,
wherein the common OEM entity is associated with subscription managed discovery service (SM-DS), and
wherein the MNO entity is associated with subscription manager data preparation (SM-DP).

7. The target device of claim 5,
wherein the instructions, when executed by the at least one processor, cause the target device to:
detect based on polling of events at the common OEM entity, presence of respective events at the common OEM entity, and
wherein, based on polling of the respective events at the common OEM entity, the respective events at the source device and the target device are processed.

8. A mobile network operator (MNO) entity comprising:
a transceiver;
at least one processor; and
at least one memory storing instructions,
wherein the instructions, when executed by the at least one processor, cause the MNO entity to:
receive, from a user associated with a target device, a request to transfer an embedded subscriber identity module (e-sim) from a source device to the target device, wherein the source device is associated with a source original equipment manufacturer (OEM) entity and the target device is associated with a target OEM entity different from the source OEM entity,
request the target OEM entity to register the e-sim with the target OEM entity,
generate a new profile of the e-sim, and
transmit the new profile to the target device via the target OEM entity for download and activation at the target device, thereby completing the transfer of the e-sim.

9. The MNO entity of claim 8,
wherein the instructions, when executed by the at least one processor, cause the MNO entity to:
record the generation of the new profile at an MNO ledger associated with the MNO entity, and
wherein the registration of the e-sim at a target ledger associated with the target OEM entity is tokenized by delinking an integrated circuit card identifier (ICCID) of the e-sim from the SM-DS of the source OEM entity and embedded universal integrated circuit card (eUICC) of the source device and linking the ICCID of the e-sim to the SM-DS of the target OEM entity and eUICC of the target device.

10. The MNO entity of claim 9,
wherein the instructions, when executed by the at least one processor, cause the MNO entity to:
generate a delete event indicating deletion of the e-sim from the source device by delinking the ICCID of the e-sim from the SM-DS of the source OEM and the eUICC of the source device, and
transmit the delete event to the source OEM entity, and
wherein the e-sim is deleted based on the delete event at the source OEM entity.

11. The MNO entity of claim 8,
wherein the MNO entity comprises a database configured to store a device priority data unit indicating corresponding embedded universal integrated circuit card (eUICC) identifiers and corresponding priorities of the source device associated with the source OEM, the target device associated with the target OEM, and one or more additional devices with respect to each other,
wherein the source device, the target device, and the one or more additional devices are registered at the device priority data unit using corresponding eUICCs via a user account, and
wherein the device priority data unit is accessed and updated via a user account by a user of the source device and the target device.

12. The MNO entity of claim 11,
wherein a third-party discovery server performs one or more operations of the MNO entity, and
wherein the one or more operations include operations to:
store the device priority data unit at the third-party discovery server, update the device priority data unit,
monitor the transfer of e-sim from the source device to the target device,
perform transfer transactions and maintain a target ledger associated with the target OEM entity, and
communicate with the target OEM entity and the source OEM entity.

13. A method performed by a target device, the method comprising:
detecting, by the target device, a request to transfer an embedded subscriber identity module (e-sim) from a source device to the target device, wherein the source device and the target device are associated with a common original equipment manufacturer (OEM) entity; and
receiving, by the target device from a mobile network operator (MNO) entity, a new profile for the e-sim for download and activation at the target device, thereby completing the transfer of the e-sim,
wherein a determination that the target device is prior to the source device is performed by the common OEM entity, and
wherein a first transaction indicative of a request to generate the new profile for the e-sim for the target device and deletion of the e-sim from the source device is triggered by the common OEM entity upon the determination.

14. The method of claim 13,
wherein the first transaction at a first ledger associated with the common OEM entity is recorded by the common OEM entity,
wherein a second transaction indicative of a generation of the new profile and the transfer of the e-sim to the target device is triggered by the MNO entity, and
wherein the second transaction at a second ledger associated with the MNO entity is recorded by the MNO entity.

15. The method of claim 13, wherein detecting the request to transfer the e-sim comprises:
detecting, at a private cloud associated with a user of the target device and the source device, a transfer event indicating that a transfer to the target device is required;
determining whether the transfer event fulfills a predetermined criteria; and
detecting the request to transfer the e-sim upon a determination that the transfer event fulfills the predetermined criteria.

16. The method of claim 13, wherein detecting the request to transfer the e-sim comprises receiving a user request indicative of initiation of the transfer of e-sim from the source device to the target device.

17. The method of claim 13, wherein the determination is based on a database of the common OEM entity, the database storing a device priority data unit indicating a priority of the source device, the target device, and one or more additional devices with respect to each other, corresponding identifiers and states of the source device, the target device, and one or more additional devices.

18. A method performed by a mobile network operator (MNO) entity having an MNO controller, the method comprising:
receiving, by the MNO entity from a user associated with a target device, a request to transfer an embedded subscriber identity module (e-sim) from a source device to the target device, wherein the source device is associated with a source original equipment manufacturer (OEM) entity and the target device is associated with a target OEM entity different from the source OEM entity;
requesting, by the MNO entity, the target OEM entity to register the e-sim with the target OEM entity;
generating, by the MNO entity, a new profile of the e-sim; and
transmitting, by the MNO entity, the new profile to the target device via the target OEM entity for download and activation at the target device, thereby completing the transfer of the e-sim.

19. The method of claim 18, further comprising:
recording the generation of the new profile at an MNO ledger associated with the MNO controller,
wherein the registration of the e-sim at a target ledger associated with the target OEM entity is tokenized by delinking an integrated circuit card identifier (ICCID) of the e-sim from a subscription managed discovery service (SM-DS) of the source OEM entity and an embedded universal integrated circuit card (eUICC) of the source device and linking the ICCID of the e-sim to the SM-DS of the target OEM entity and eUICC of the target device.

20. The method of claim 19, further comprising:
generating a delete event indicating deletion of the e-sim from the source device by delinking the ICCID of the e-sim from the SM-DS of the source OEM and the eUICC of the source device; and
transmitting the delete event to the source OEM entity,
wherein the e-sim is deleted based on the delete event at the source OEM entity.
